(19) United States
(12) Patent Application Publication
(10) Pub. No.: US 2015/0339578 A1
(43) Pub. Date: Nov. 26, 2015

(54) A METHOD AND SYSTEM FOR PROVIDING RECOMMENDATIONS

(71) Applicant: THOMSON LICENSING, Issy de Moulineaux (FR)

(72) Inventors: Pedro OLIVEIRA, San Francisco, CA (US); Branislav Kveton, San Jose, CA (US)

(73) Assignee: THOMSON LICENSING, Issy de Moulineaux (FR)

(21) Appl. No.: 14/410,459

(22) PCT Filed: May 30, 2013
(86) PCT No.: PCT/US2013/043297

§ 371 Date: Dec. 22, 2014

Related U.S. Application Data
(60) Provisional application No. 61/663,296, filed on Jun. 22, 2012.

(51) Int. Cl. G06N 5/04; G06N 99/00

(52) U.S. Cl. CPC G06N 5/04; G06N 99/005

(57) ABSTRACT

The disclosed embodiments relate to a system and method for providing recommendations on a multimedia device. The method includes labeling a sampling of content with associated features. The method further includes training a classifier based on the labels. The method also includes classifying a set of movies based on the movies' features. Additionally, the method includes mapping a classification space of the movies to a well-distributed space.

This application claims the benefit under 35 U.S.C. §119 of provisional application 61/663,296 which was filed in the United States on Jun. 22, 2012.

### FIELD OF THE INVENTION

The present disclosure involves operating a multimedia device. More specifically, the present disclosure relates to a system for operating a multimedia device to provide recommendations.

### BACKGROUND OF THE INVENTION

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements are to be read in this light, and not as admissions of prior art.

Home theater and entertainment systems provide content such as, movies, video games, or other multimedia experiences over a display device, such as a television. Further, the display device may be connected to a device that may include, but are not limited to, set-top boxes, streaming devices, smartphones, desktop computers, laptops, high-definition video disc players, and so on. Additionally, each of these devices may receive content from numerous content sources, including, but not limited to, cable, satellite, and Internet service providers.

Because of the wide variety of content options, many content providers have systems that make recommendations to their users. In one approach, movie recommendations are based on classifications in several specific categories, such as “Emotional”, “Feel-good”, “Inspiring”, etc. One drawback of this approach is that the categories may be abstract, or subject to varying interpretations. Another drawback is that movies are classified as either belonging to a category or not. As such, a user cannot know, based on the recommendation, how “Feel-good,” or “inspiring,” a movie may be. Additionally, the typical approaches use a tag-based navigation interface, meaning all the “Feel-good,” “Inspiring,” and “Emotional” movies may be presented near each other in the interface, or randomly presented next to “Horror,” or other unrelated classifications.

An improved system or method for making media content recommendations on a multimedia device is desirable.

### SUMMARY OF THE INVENTION

Certain aspects commensurate in scope with the present disclosure are set forth below. It should be understood that these aspects are presented merely to provide the reader with a brief summary of certain forms the present disclosure might take and that these aspects are not intended to limit the scope of the disclosure. Indeed, the present disclosure may encompass a variety of aspects that may not be set forth below.

The disclosed embodiments relate to a system and method for a personal channel on a multimedia device. More specifically, there is provided a method to provide recommendations for media content. The method includes labeling a sampling of content with associated features. The method further includes training a classifier based on the labels. The method also includes classifying a set of movies based on the movies' features. Additionally, the method includes mapping a classification space of the movies to a well-distributed space.

### BRIEF DESCRIPTION OF THE DRAWINGS

Advantages of the present disclosure may become apparent upon reading the following detailed description and upon reference to the drawings in which:

FIG. 1 is a block diagram of an exemplary system for providing recommendations in accordance with the present disclosure;

FIGS. 2A-2C are simplified block diagrams of exemplary interfaces in accordance with the present disclosure;

FIG. 3 is a flow chart of an exemplary method in accordance with the present disclosure;

FIGS. 4A and 4B are graphs representing a mapping in accordance with the present disclosure;

FIG. 5 is a simplified block diagram of an exemplary interface in accordance with the present disclosure;

FIG. 6 is a block diagram of a receiving device in accordance with the present disclosure;

FIG. 7 is a perspective view of an exemplary touch panel device in accordance with the present disclosure; and

FIG. 8 is a diagram of exemplary gestures for a gesture sensing controller or touch screen interface in accordance with the present disclosure.

It should be understood that the drawings are for purposes of illustrating the concepts of the disclosure. The drawings are not necessarily the only possible configuration for illustrating the disclosure.

### DETAILED DESCRIPTION

One or more specific embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking for those of ordinary skill having the benefit of this disclosure.

The elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for instructional purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The proposed disclosure is directed towards a movie recommendation and discovery engine based on an implicit mood of the movie. A simple user navigation interface enables a user to select the mood of the film the user would like to see. Additionally, the interface presents recommendations of movies that fit the selected mood.

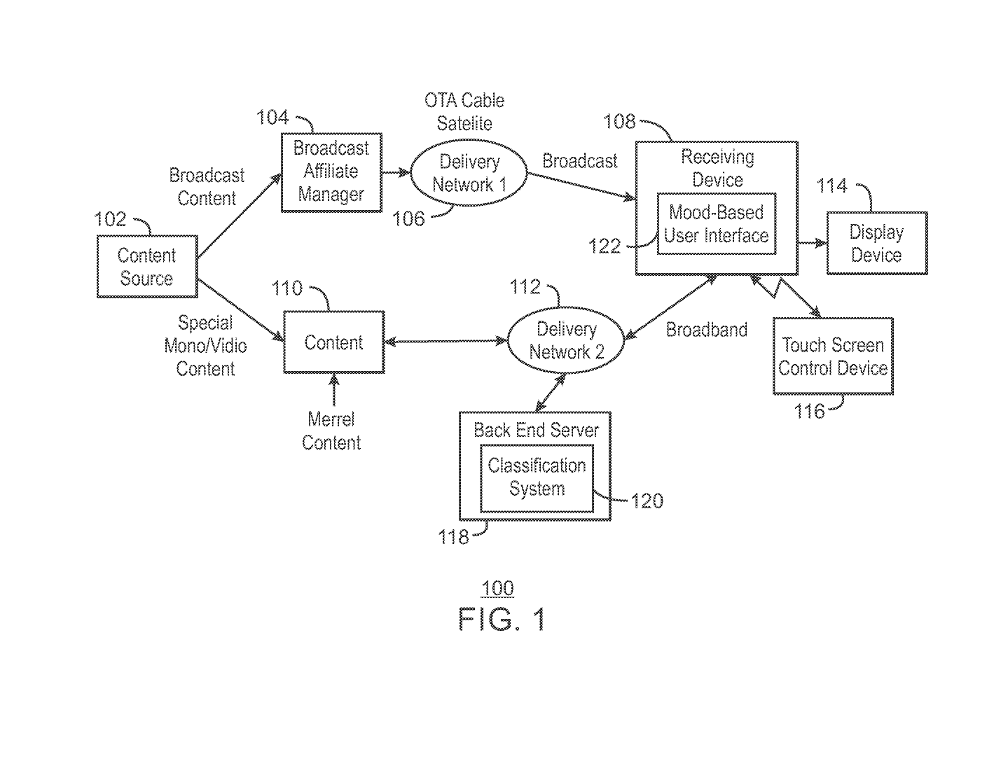

Turning now to FIG. 1, which is a block diagram of an exemplary system for providing recommendations in accordance with the present disclosure. The content originates from a content source 102, such as a movie studio or production house. The content may be supplied in at least one of two forms. One form may be a broadcast form of content. The broadcast content is provided to the broadcast affiliate manager 104, which is typically a broadcast service, such as a television broadcast service. The broadcast affiliate manager may collect and store the content, and may schedule delivery of the content over a delivery network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a receiving device 108. It is to be appreciated that the receiving device 108 can take many forms and may be embodied as a set top box, digital video recorder (DVR), a gateway, a modem, etc. Further, the receiving device 108 may act as an entry point, or gateway, for a home network system that includes additional devices configured as either client or peer devices in the home network.

A second form of content is referred to as special content. Special content may include content delivered as premium viewing, pay-per-view, or other content otherwise not provided to the broadcast affiliate manager, e.g., movies, video games or other video elements. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system. The content manager 110 may deliver the content to the user's receiving device 108 over a separate delivery network, delivery network 2 (112). Delivery network 2 (112) may include high-speed broadband Internet type communications systems. It is noted that the content from the broadcast affiliate manager 104 may also be delivered using all or parts of delivery network 2 (112), and that content from the content manager 110 may be delivered using all or parts of delivery network 1 (106). In addition, the user may also obtain content directly from the Internet via delivery network 2 (112) without necessarily having the content managed by the content manager 110.

Several adaptations for using the separately delivered content may be possible. In one possible approach, the special content is provided as an augmentation to the broadcast content, providing alternative displays, purchase and merchandising options, enhancement material, etc. In another embodiment, the special content may completely replace some programming content provided as broadcast content. Finally, the special content may be completely separate from the broadcast content, and may simply be a media alternative that the user may choose to utilize. For instance, the special content may be a library of movies that are not yet available as broadcast content.

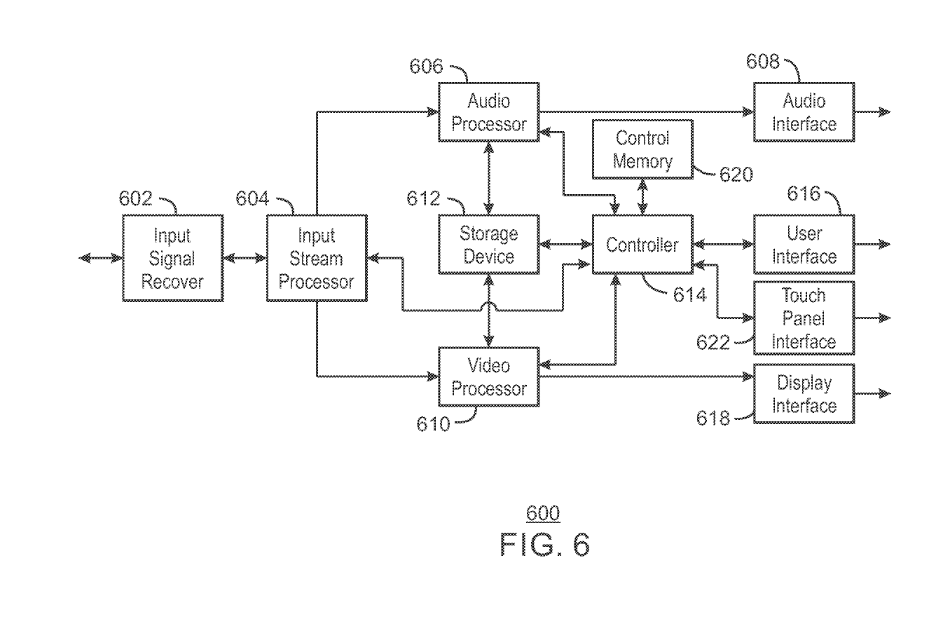

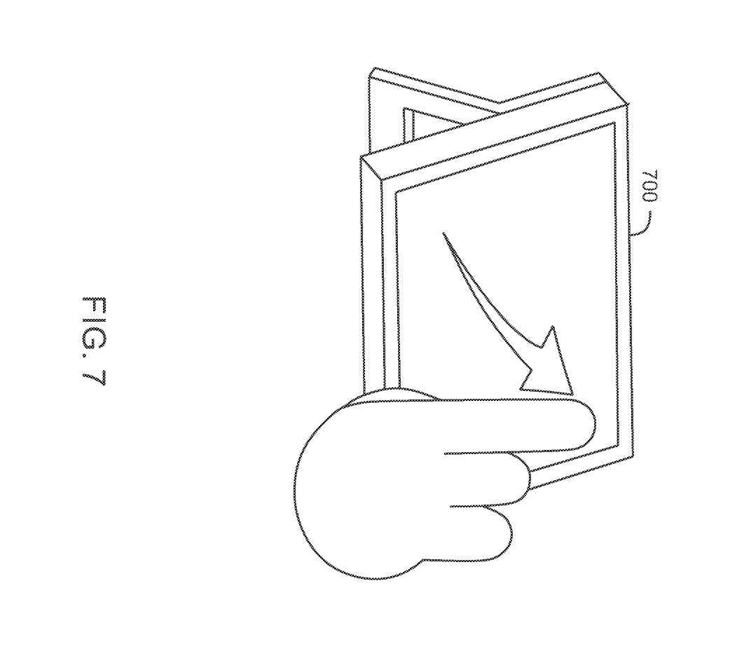

The receiving device 108 may receive different types of content from one or both of delivery network 1 and delivery network 2. The receiving device 108 processes the content, and provides a separation of the content based on user preferences and commands. The receiving device 108 may also include a storage device, such as a hard drive or optical disk drive, for recording and playing back audio and video content. Further details of the operation of the receiving device 108 and features associated with playing back stored content will be described below in relation to FIG. 6. The processed content is provided to a display device 114. The display device 114 may be a conventional 2-D type display or may alternatively be an advanced 3-D display.

The receiving device 108 may also be interfaced to a second screen such as a touch screen control device 116. The touch screen control device 116 may be adapted to provide user control for the receiving device 108 and the display device 114. The touch screen device 116 may also be capable of displaying video content. The video content may be graphics entries, such as user interface entries (as discussed below), or may be a portion of the video content that is delivered to the display device 114. The touch screen control device 116 may interface to receiving device 108 using any well-known signal transmission system, such as infra-red (IR) or radio frequency (RF) communications and may include standard protocols such as infra-red data association (IRDA) standard, Wi-Fi, Bluetooth and the like, or any other proprietary protocols. Operations of touch screen control device 116 will be described in further detail below.

Optionally, media device 108 and touch screen control device 116 may be integrated into the same device. Examples of media devices with a touch screen include, but are not limited to, computers, laptops, wireless phones, cell phones, personal media players, MP3 players, personal digital assistants (PDAs), tablet devices, digital video recorders, gateways, and the like. For purposes of the specification, the term media device can encompass all of these types of devices.

In the example of FIG. 1, the system 100 also includes a back end server 118. As discussed in further detail below, the back end server 118 includes a classification system 120 for movie recommendations based on a specified mood. The classification system 120 includes a trained classifier that classifies movies with respect to two different continuous variables: valence, ranging from dark to positive, and energy, ranging from calm to energetic. In the present example, the back end server 118 is connected to the system 100 and accessed through the delivery network 2 (112).

The receiving device 108 includes a mood-based user interface 122. The mood-based user interface 122 may be presented on the display, the touch screen control device 116, or other input-output (I/O) devices. Given a large set of movies with their moods, the mood-based user interface 122 allows users to navigate and discover movies in a two-dimensional valence and energy space. Valence may include a range of values representing a tone of the content (e.g., from positive to negative), and energy may include a range of values representing a pace of the content (e.g., from calm to energetic).

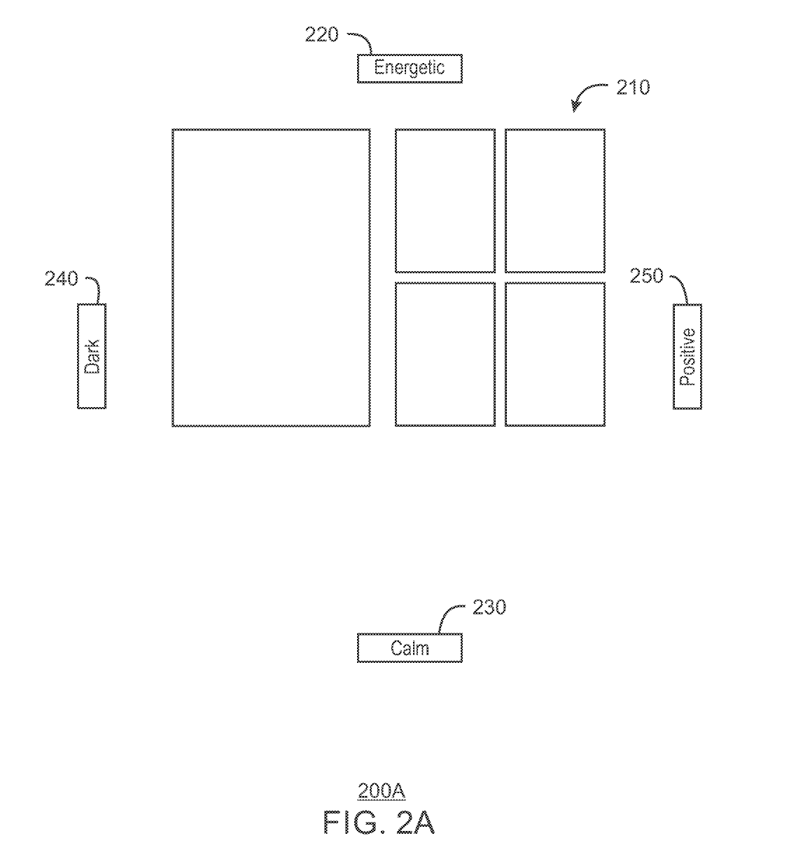

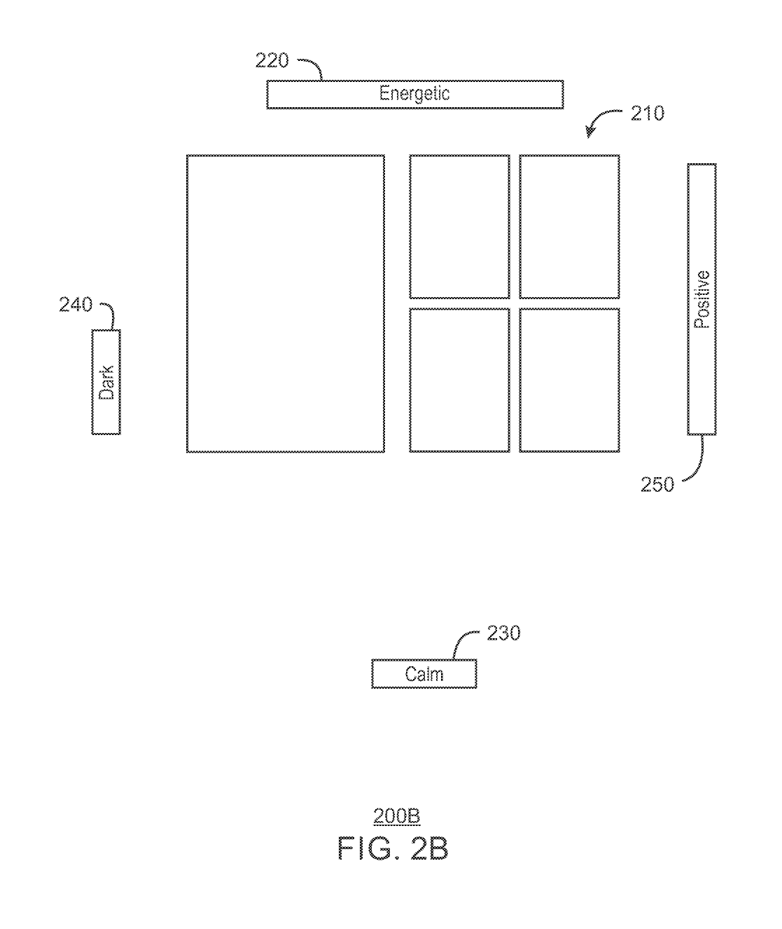

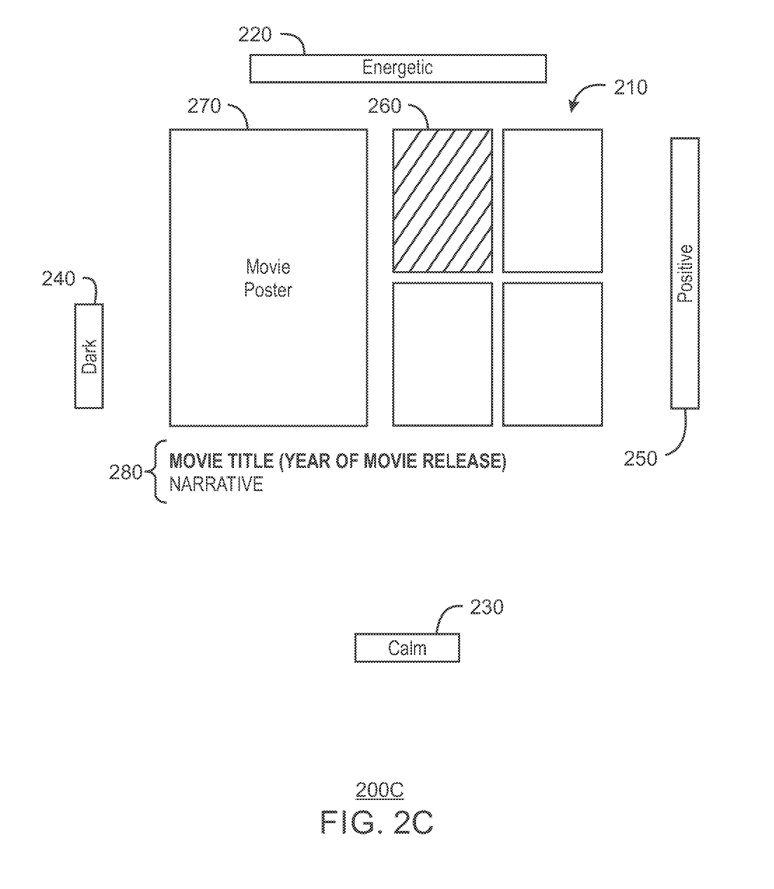

FIGS. 2A-2C are simplified block diagrams of exemplary interfaces in accordance with the present disclosure. Referring now to FIG. 2A, which is an exemplary embodiment of a user interface 200A showing a collection of media assets or objects, represented as thumbnails 210. Media assets may include, but are not limited to, movies, albums, songs, games, websites, books, or the like. The interface 200 includes mood bars 220-250. The mood bars 220-250 represent the level of valence and energy of the media assets represented by the thumbnails 210. Additionally, the mood bars 220-250 indicate the direction to swipe to find movies associated with a particular mood. For example, “darker” movies may be selected by swiping the interface rightwards, i.e. moving the more positive movies off-screen, and the darker movies on-screen. For more “positive” movies, a user may swipe leftwards. If the user desires more “energetic” movies, the user may swipe downwards, moving the more calm movies off-screen and the more energetic movies on-screen. If the user desires more “calm” movies, the user may swipe upwards. Diagonal swipes are also possible to select movies that are both, for example, more energetic and more positive (left, downward diagonal swipe), less energetic and more positive (left, upward diagonal swipe), and so on.

In one embodiment, the size of the mood bars 220-250 may be adjusted with hand gestures to change the movies presented on the interface. In such an embodiment, a change to one mood bar changes the size of the opposing mood bar. For example, reducing the size of the “positive” bar 250 results in an increase in the size of the “dark” bar 240, and a new selection of movies presented based on the changed mood.

Referring now to FIG. 2B, the mood bars 220-250 change size (e.g., length) as the user navigates through the mood grid. For example, as shown in FIG. 2B, the user has navigated towards more energetic and positive movies, and away from dark and calm movies. As a result, the energetic mood bar 220 and positive mood bar 250 have increased in size and the dark mood bar 240 and calm mood bar 230 have decreased in size. The change in the size of the mood bars 220-250 provides useful feedback to the user indicating the current position in the mood grid.

Referring now to FIG. 2C, once the user has navigated to a desired position with the mood grid, the user can select a movie 260 to obtain additional information about the movie, to download the movie, to purchase the movie, or to play the movie. For example, a poster 270 may be shown for the selected movie. Additionally, the movie title, year of release and a brief narrative may be provided in an additional information section 280.

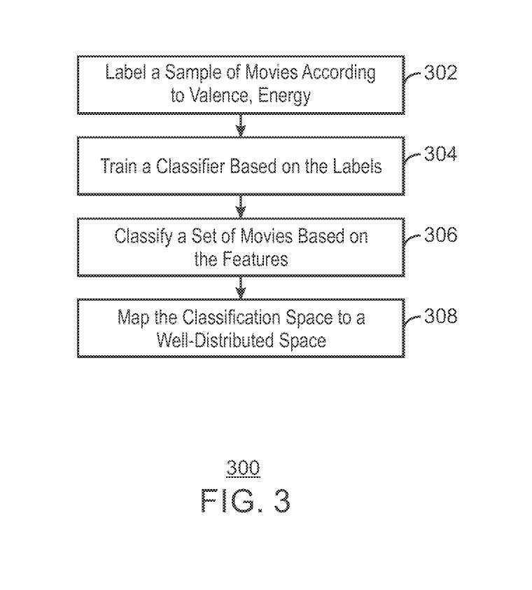

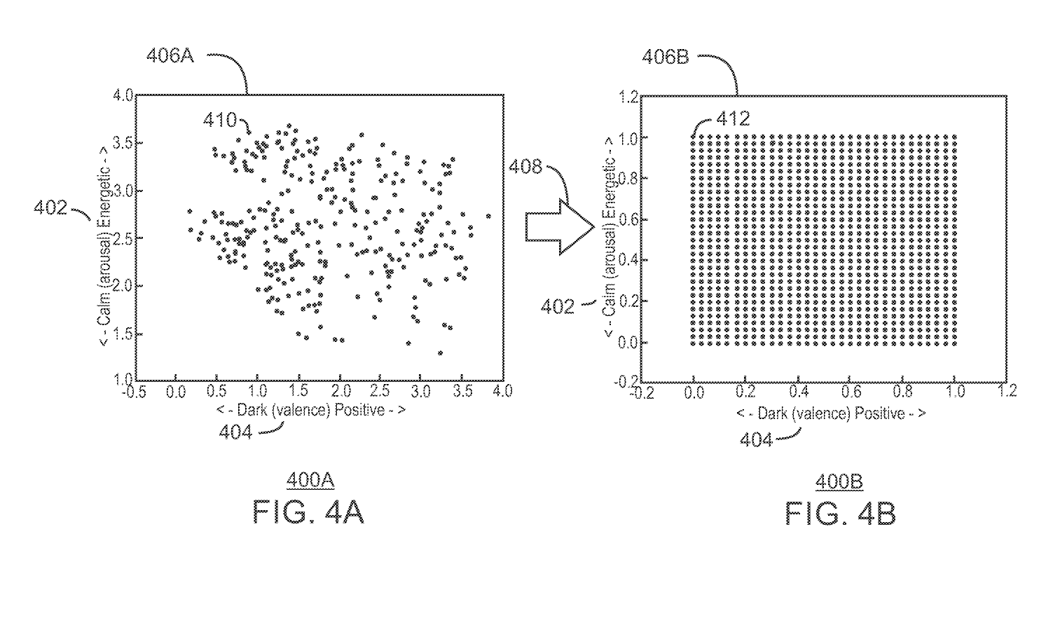

FIG. 3 is a flow chart of an exemplary method 300 in accordance with the present disclosure. At block 302, a sample of movies is labeled according to their valence and energy level. The labeling is described in greater detail with respect to FIG. 4. The labeled valence and energy levels for each movie may be averaged. At block 304, the averaged results are used to train a classifier, such as a kernel-based regression machine. The classifier is trained to predict valence and energy levels based on the movies' features, e.g., genres. At block 306, a set of movies is classified, i.e., associated with valence and energy levels, based on the movies' genres. This classification creates a classification space in the two dimensions of valence and energy levels

At block 308, the classification space is mapped to a well-distributed space. In one embodiment, the classification space is mapped to a well distributed space using, for example, maximum bipartite matching techniques as known by those skilled in the art.

FIGS. 4A and 4B are graphs 400A, 400B representing a mapping 408 in accordance with the present disclosure. Graph 400A represents each movie as a point 410 in the energy dimension 402 and the valence dimension 404. The classification space 406A may be partitioned into a squared grid 406B, with each movie belonging to a specific cell 410 in the grid 406B. As discussed above, the partitioning or mapping of the classification space 406A into a squared grid 406B may be accomplished using, for example, maximum bipartite matching techniques. It is important to note that the partitioning or mapping preferably maintains the valence and energy relationships between the movies. In other words, the valence and energy values attributed to movies in classification space 406A is at least reflected, and preferably, if possible, maintained for the movies when the movies are partitioned or mapped to the well distributed space 406B (e.g., an array, multidimensional grid or other appropriate graphical representation). The user interface 200 retrieves information about each movie from a cell 412 in the grid 406B. In this way, the user may navigate to specific cells 412 in the valence and energy-level dimensions 402, 404, and retrieve information about movies according to the selected mood, i.e., valence and energy level.

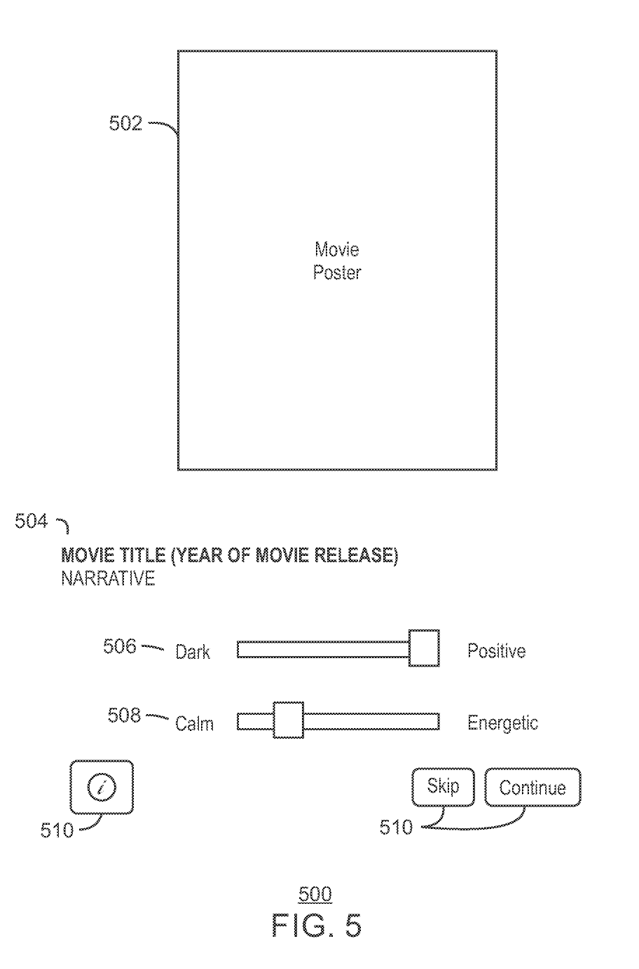

FIG. 5 is a simplified block diagram of an exemplary interface 500 in accordance with the present disclosure. The interface 500 is used to acquire the ground truth for the classification system 120. The ground truth provides a baseline sampling of genre-specific movies that are labeled by a sampling group according to valence and energy levels. The classification system 120 takes this sampling to train a classifier to predict valence and energy levels for other movies based on their genre. The interface 500 includes a graphic for movie poster 502, additional information 504 about the movie, rating selections for valence and energy levels 506, 508. Additional buttons 510 may be provided for instructing the labeling user how to use the interface 500, or for proceeding to the next movie to label.

Turning now to FIG. 6, which is a block diagram of a receiving device 600 in accordance with the present disclosure. The receiving device 600 may include a set-top box, digital video recorder (DVR), or other device that operates similar to the receiving device 108 described in FIG. 1 and may be included as part of a gateway device, modem, set-top box, or other similar communications device. The device 600 shown may also be incorporated into other systems including an audio device or a display device. In either case, several components necessary for complete operation of the system are not shown in the interest of conciseness, as they are well known to those skilled in the art.

In the device 600 shown in FIG. 6, the content is received by an input signal receiver 602. The input signal receiver 602 may be one of several known receiver circuits used for receiving, demodulation, and decoding signals provided over one of the several possible networks including over the air, cable, satellite, Ethernet, fiber and phone line networks. The desired input signal may be selected and retrieved by the input signal receiver 602 based on user input provided through a control interface or touch panel interface 622. Touch panel interface 622 may include an interface for a touch screen device. Touch panel interface 622 may also be adapted to interface to a cellular phone, a tablet, a mouse, a high end remote or the like.

The decoded output signal is provided to an input stream processor 604. The input stream processor 604 performs the final signal selection and processing, and includes separation of video content from audio content for the content stream. The audio content is provided to an audio processor 606 for conversion from the received format, such as compressed digital signal, to an analog waveform signal. The analog waveform signal is provided to an audio interface 608 and further to the display device or audio amplifier. Alternatively, the audio interface 608 may provide a digital signal to an audio output device or display device using a High-Definition Multimedia Interface (HDMI) cable or alternate audio interface such as via a Sony/Philips Digital Interconnect Format (SPDIF). The audio interface may also include amplifiers for driving one more sets of speakers. The audio processor 606 also performs any necessary conversion for the storage of the audio signals.

The video output from the input stream processor 604 is provided to a video processor 610. The video signal may be one of several formats. The video processor 610 provides, as necessary a conversion of the video content, based on the input signal format. The video processor 610 also performs any necessary conversion for the storage of the video signals.

A storage device 612 stores audio and video content received at the input. The storage device 612 allows later retrieval and playback of the content under the control of a controller 614 and also based on commands, e.g., navigation instructions such as fast-forward (FF) and rewind (Rew), received from a user interface 616 and/or touch panel interface 622. The storage device 612 may be a hard disk drive, one or more large capacity integrated electronic memories, such as static RAM (SRAM), or dynamic RAM (DRAM), or may be an interchangeable optical disk storage system such as a compact disk (CD) drive or digital video disk (DVD) drive.

The converted video signal, from the video processor 610, either originating from the input or from the storage device 612, is provided to the display interface 618. The display interface 618 further provides the display signal to a display device of the type described above. The display interface 618 may be an analog signal interface such as red-green-blue (RGB) or may be a digital interface such as HDMI. It is to be appreciated that the display interface 618 will generate the various screens for presenting the search results (e.g., in a three dimensional gird, two dimensional array, and/or a shelf as will be described in more detail below).

The controller 614 is interconnected via a bus to several of the components of the device 600, including the input stream processor 602, audio processor 606, video processor 610, storage device 612, and a user interface 616. The controller 614 manages the conversion process for converting the input stream signal into a signal for storage on the storage device or for display. The controller 614 also manages the retrieval and playback of stored content. Furthermore, as will be described below, the controller 614 performs searching of content and the creation and adjusting of the grid, array and/or shelf display representing the content, either stored or to be delivered via the delivery networks, described above.

The controller 614 is further coupled to control memory 620 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 614. Control memory 620 may store instructions for controller 614. Control memory may also store a database of elements, such as graphic elements containing content. The database may be stored as a pattern of graphic elements, such as graphic elements containing content, various graphic elements used for generating a displayable user interface for display interface 618, and the like. Alternatively, the memory may store the graphic elements in identified or grouped memory locations and use an access or location table to identify the memory locations for the various portions of information related to the graphic elements. Additional details related to the storage of the graphic elements will be described below. Further, the implementation of the control memory 620 may include several possible embodiments, such as a single memory device or, alternatively, more than one memory circuit communicatively connected or coupled together to form a shared or common memory. Still further, the memory may be included with other circuitry, such as portions of bus communications circuitry, in a larger circuit.

Optionally, controller 614 can be adapted to extract metadata, criteria, characteristics or the like from audio and video media by using audio processor 606 and video processor 610, respectively. That is, metadata, criteria, characteristics or the like that is contained in video signal in the vertical blanking interval, auxiliary data fields associated with video, or in other areas in the video signal can be harvested by using the video processor 610 with controller 614 as to generate metadata that can be used for functions such as generating an electronic program guide, have descriptive information about received video, supporting an auxiliary information service, and the like. Similarly, the audio processor 606 working with controller 614 can be adapted to recognize audio watermarks that may be in an audio signal. Such audio watermarks can then be used to perform some action such as the recognition of the audio signal, security which identifies the source of an audio signal, or perform some other service. Furthermore, metadata, criteria, characteristics or the like, to support the actions listed above can come from a network source which are processed by controller 614.

Turning now to FIG. 7 is a perspective view of an exemplary touch panel device 700 in accordance with the present disclosure. The user interface process of the present disclosure employs an input device that can be used to express functions, such as described with reference to selecting the mood of the movies for recommendation. The device may include a controller, touch screen device, tablet, any other device as described with reference to the touch screen device 116 shown in FIG. 1, or any integrated examples of the receiving device 108 and touch screen device 116. The touch panel device 700 may be interfaced via the user interface 616 or touch panel interface 622 of the receiving device 600. The touch panel device 700 allows operation of the receiving device or set top box based on hand movements, or gestures, and actions translated through the panel into commands for the set top box or other control device. In one embodiment, the touch panel 700 may simply serve as a navigational tool to navigate the grid display. In other embodiments, the touch panel 700 will additionally serve as the display device allowing the user to more directly interact with the navigation through the grid display of content. The touch panel device may be included as part of a remote control device containing more conventional control functions such as activator and/or actuator buttons. The touch panel 700 can also include at least one camera element. As described above, the touch panel device 700 (or display device 114) may use a media asset discovery function to provide media recommendations to a user.

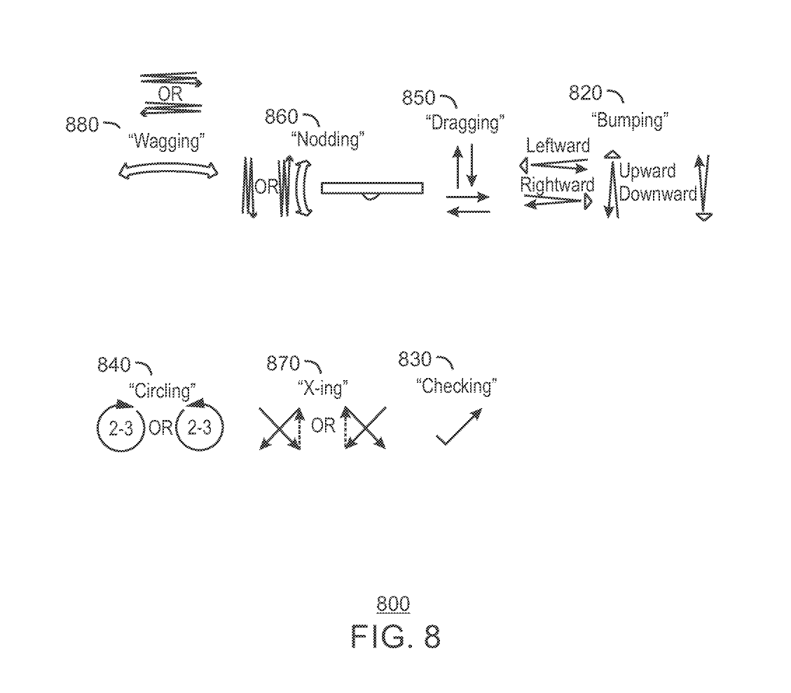

Turning now to FIG. 8, which is a diagram 800 of exemplary gestures for a gesture sensing controller or touch screen interface in accordance with the present disclosure. The use of a gesture sensing controller (e.g., a controller using movement detection sensors such as, but not limited to, cameras, gyroscopes, accelerometers and the like) or touch screen, such as shown, provides for a number of types of user interaction. The inputs from the controller are used to define gestures and the gestures, in turn, define specific contextual commands. The configuration of the sensors (e.g., touch screen sensor and/or inertial sensors such as accelerometer and gyroscope sensors) may permit defining movement of a user's fingers on a touch screen or may even permit defining the movement of the controller itself in either one dimension or two dimensions. Two-dimensional motion, such as a diagonal, and a combination of yaw, pitch and roll can be used to define any three-dimensional motion, such as a swing. A number of gestures are illustrated in FIG. 8. Gestures are interpreted in context and are identified by defined movements made by the user.

Bumping 820 is defined by a two-stroke drawing indicating pointing in one direction, either up, down, left or right. The bumping gesture is associated with specific commands in context. For example, in a TimeShifting mode, a left-bump gesture 820 indicates rewinding, and a right-bump gesture indicates fast-forwarding. In other contexts, a bump gesture 820 is interpreted to increment a particular value in the direction designated by the bump. Checking 840 is defined as in drawing a checkmark. It is similar to a downward bump gesture 820. Checking is identified in context to designate a reminder, user tag or to select an item or element. Circling 840 is defined as drawing a circle in either direction. It is possible that both directions could be distinguished. However, to avoid confusion, a circle is identified as a single command regardless of direction. Dragging 850 is defined as an angular movement of the controller (a change in pitch and/or yaw) while pressing a button (virtual or physical) on the tablet 700 (i.e., a “trigger drag”). The dragging gesture 850 may be used for navigation, speed, distance, time-shifting, rewinding, and forwarding. Dragging 850 can be used to move a cursor, a virtual cursor, or a change of state, such as highlighting outlining or selecting on the display. Dragging 850 can be in any direction and is generally used to navigate in two dimensions. However, in certain interfaces, it is preferred to modify the response to the dragging command. For example, in some interfaces, operation in one dimension or direction is favored with respect to other dimensions or directions depending upon the position of the virtual cursor or the direction of movement. Nodding 860 is defined by two fast trigger-drag up-and-down vertical movements. Nodding 860 is used to indicate “Yes” or “Accept.” X-ing 870 is defined as in drawing the letter “X.” X-ing 870 is used for “Delete” or “Block” commands. Wagging 880 is defined by two trigger-drag fast back-and-forth horizontal movements. The wagging gesture 880 may be used to indicate “No” or “Cancel” or to move displayed or virtual objects (e.g. cursors) horizontally.

Depending on the complexity of the sensor system, only simple one dimensional motions or gestures may be allowed. For instance, a simple right or left movement on the sensor as shown here may produce a fast forward or rewind function. In addition, multiple sensors could be included and placed at different locations on the touch screen. For instance, a horizontal sensor for left and right movement may be placed in one spot and used for volume up/down, while a vertical sensor for up and down movement may be place in a different spot and used for channel up/down. In this way specific gesture mappings may be used.

Although embodiments which incorporate the teachings of the present disclosure have been shown and described in detail herein, those skilled in the art can readily devise many other varied embodiments that still incorporate these teachings. Having described preferred embodiments of a system, method and user interface for media asset recommendations (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure.

1. A method for a multimedia device, comprising:
training a classifier based on a plurality of valence labels and a plurality of energy labels, wherein the valence labels and the energy labels are associated with a plurality of content, wherein the content is associated with a plurality of features;
classifying a set of content based on the features; and
mapping a classification space of the content to a well-distributed space.

2. The method of claim 1, wherein the valence labels comprise a range of values representing a tone of the content, from positive to negative, and wherein the energy labels comprise a range of values representing a pace of the content, from calm to energetic.

3. The method of claim 2, wherein mapping the classification space comprises maximum bipartite matching.

4. The method of claim 3, wherein the well-distributed space comprises a two-dimensional (2D) space.

5. The method of claim 3, wherein mapping the classification space of the content comprises generating a multidimensional grid, wherein each cell of the multidimensional grid comprises one content item, and wherein a position of the cell in the multidimensional grid represents an energy value and a valence value.

6. The method of claim 5, comprising, in response to a selection of a specific valence value, and a selection of a specific energy value, determining a presentation subset of the content based on the selected valence value and the selected energy value.

7. The method of claim 6, comprising presenting descriptions of content items in relative position to each other according to the multidimensional grid.

8. The method of claim 1, wherein the features comprise at least one genre of the content.

9. A multimedia device configured to:
train a classifier based on a plurality of valence labels and a plurality of energy labels, wherein the valence labels and the energy labels are associated with a plurality of content, wherein the content is associated with a plurality of features;
classify a set of content based on the classifier and the features; and
map a classification space of the set of content to a well-distributed space.

10. The multimedia device of claim 9, wherein the valence labels comprise a range of values representing a tone of the content, from positive to negative, and wherein the energy labels comprise a range of values representing a pace of the content, from calm to energetic.

11. The multimedia device of claim 10, wherein the classification space is mapped with maximum bipartite matching.

12. The multimedia device of claim 11, wherein the well-distributed space comprises a two-dimensional (2D) space.

13. The multimedia device of claim 11, wherein the classification space of the content is mapped by generating a multidimensional grid, wherein each cell of the multidimensional grid comprises one content item, and wherein a position of the cell in the multidimensional grid represents an energy value and a valence value.

14. The multimedia device of claim 13, wherein, in response to a selection of a specific valence value, and a selection of a specific energy value, a presentation subset of the content is determined based on the specific valence value and the specific energy value.

15. The multimedia device of claim 14, wherein descriptions of content items are presented in relative position to each other according to the multidimensional grid.
